(19) United States
(12) Patent Application Publication
(10) Pub. No.: US 2018/0081526 A1
(43) Pub. Date: Mar. 22, 2018

(54) DISPLAY DEVICE AND CONTROLLING METHOD THEREOF

(71) Applicant: SAMSUNG ELECTRONICS CO., LTD., Suwon-si (KR)

(72) Inventors: Young Deok CHOI, Seoul (KR); Ho Woong KANG, Yongin-si (KR)

(73) Assignee: SAMSUNG ELECTRONICS CO., LTD., Suwon-si (KR)

(21) Appl. No.: 15/708,502

(22) Filed: Sep. 19, 2017

(30) Foreign Application Priority Data
Sep. 19, 2016 (KR) 10-2016-0119480

(51) Int. Cl. G06F 3/0484

(52) U.S. Cl. CPC G06F 3/04845; G06F 2203/04804

(57) ABSTRACT

A display device includes a housing disposed at an exterior of the display device, a display exposed to an outside through a first surface of the housing from among a plurality of surfaces of the housing, an input interface disposed on at least one surface of the housing other than the first surface and receiving a user input, and a processor. The processor, if a first user input is received through the input interface, displays a first user interface (UI) corresponding to the first user input on the display, and, if a predetermined time elapses after the first UI is displayed, displays a second UI on the display and performs an operation corresponding to the first user input.

### CROSS-REFERENCE TO RELATED APPLICATION(S)

This application claims priority from Korean patent application 10-2016-0119480, filed on Sep. 19, 2016 in the Korean Intellectual Property Office, the entire disclosure of which is incorporated herein by reference.

### BACKGROUND

### 1. Field

Apparatuses and methods consistent with example embodiments relate to a display device that displays a user interface (UI) depending on a user input and performs an operation corresponding to the user input, and a controlling method thereof.

### 2. Description of Related Art

With the development of electronic technologies, various types of electronic products are being developed and distributed. In particular, a display device such as a television (TV), a monitor, and the like, has been increasingly distributed in recent years.

As electronic devices are miniaturized, the bezel of the display device gradually becomes narrower. To improve a design, an input device or the like included in a front surface of a conventional display device is disposed on a rear surface or a side surface of the display device, and the size of the input device also becomes smaller.

### SUMMARY

In a case in which an input device is disposed on a rear surface or a side surface of a display device, a user may find it difficult to visually verify the location of the input device. Accordingly, an error may occur in the user input, and a function that is not intended by the user may be performed. In particular, in a case in which a size of the input device is small, the error of the user input may occur more frequently.

Aspects of example embodiments address at least the above-mentioned problems and/or disadvantages and provide at least the advantages described below. Accordingly, an aspect of example embodiments is to provide a display device and a controlling method thereof that displays a UI such that the UI corresponds to a user input and performs an operation corresponding to the user input if a specified time elapses after the user input is received (or after the UI is displayed), thereby preventing a malfunction.

According to an aspect of an example embodiment, there is provided a display device including: a housing disposed at an exterior of the display device; a display exposed to an outside through a first surface of the housing from among a plurality of surfaces of the housing; an input interface disposed on at least one surface of the housing other than the first surface, the input interface being configured to receive a user input; and a processor configured to: in response to a first user input being received through the input interface, control the display to display a first user interface (UI) corresponding to the first user input on the display; and in response to a predetermined time elapsing after the first UI is displayed, control the display to display a second UI on the display and perform an operation corresponding to the first user input.

The first UI may include a first object and a second object, the first object corresponding to the first user input, wherein the processor may be further configured to: control the display to display the first object distinguished from the second object.

The processor may be further configured to: control the display to display the second UI in which at least one from among a shape, a color, a size, transparency, and a display period of at least a part of the first object and the second object, is changed.

The processor may be further configured to: in response to the first user input being received, control the display to display the first UI in which at least a partial area of the first object is displayed in color and a remainder of the partial area of the first object and the second object are displayed in gray; and in response to the predetermined time elapsing after the first UI is displayed, control the display to display the second UI in which the first object and the second object are displayed in color.

The processor may be further configured to: in response to the first user input being received, control the display to display the first UI in which the first object is displayed at a first size and display the second object at a second size smaller than the first size; and in response to the predetermined time elapsing after the first UI is displayed, control the display to display the second UI in which the first object and the second object are displayed at the second size.

The processor may be further configured to: in response to the first user input being received, control the display to display the first UI in which the first object is displayed with a first transparency and the second object is displayed with a second transparency higher than the first transparency; and in response to the predetermined time elapsing after the first UI is displayed, control the display to display the second UI in which the first object and the second object are displayed with the first transparency.

The processor may be further configured to: in response to the first user input being received, control the display to display the first UI in which the first object is displayed using a first display period and display the second object using a second display period longer than the first display period; and in response to the predetermined time elapsing after the first UI is displayed, control the display to display the second UI in which the first object and the second object are displayed using the second display period.

The input interface may include at least one from among a button, a touch pad, and a jog-shuttle.

The processor may be further configured to: in response to the first user input being received, control the display to display a third UI on the display; and change at least one from among a location, a color, a size, a shape, transparency, and a display period of the third UI during the predetermined time.

The processor may be further configured to: in response to a second user input being received before the predetermined time elapses, control the display to display a fourth UI corresponding to the second user input on the display.

The processor may be further configured to: in response to the second user input being received before the predetermined time elapses, cancel the performing of the operation corresponding to the first user input; and in response to the predetermined time elapsing after the fourth UI is displayed, perform an operation corresponding to the second user input.

According to an aspect of another example embodiment, there is provided a controlling method of a display device, the method including: receiving a first user input through an input interface; displaying a first UI corresponding to the first user input in a display; in response to a predetermined time elapsing after the first UI is displayed, displaying a second UI on the display and performing an operation corresponding to the first user input.

The first UI may include a first object and a second object, the first object corresponding to the first user input, wherein the displaying of the first UI may include: displaying the first object distinguished from the second object, and wherein the displaying of the second UI may include: changing at least one from among a shape, a color, a size, transparency, and a display period of at least a part of a plurality of objects included in the first UI.

The displaying of the first UI may include: displaying at least a partial area of the first object in color; and displaying a remainder of the partial area of the first object and the second object in gray, and wherein the displaying of the second UI may include: displaying the first object and the second object in color.

The displaying of the first UI may include: displaying the first object at a first size; and displaying the second object at a second size smaller than the first size, and wherein the displaying of the second UI may include: displaying the first object and the second object at the second size.

The displaying of the first UI may include: displaying the first object with first transparency; and displaying the second object with second transparency higher than the first transparency, and wherein the displaying of the second UI may include: displaying the first object and the second object with the first transparency.

The displaying of the first UI may include: displaying the first object using a first display period; and displaying the second object using a second display period longer than the first display period, and wherein the displaying of the second UI may include: displaying the first object and the second object using the second display period.

The method may further include in response to the first user input being received, displaying a third UI on the display; and changing at least one from among a location, a color, a size, a shape, transparency, and a display period of the third UI during the predetermined time.

The method may further include: before the predetermined time elapses, receiving a second user input; and displaying a fourth UI corresponding to the second user input on the display.

The method may further include: in response to the second user input being received, canceling the performing of the operation corresponding to the first user input; and in response to the predetermined time elapsing after the fourth UI is displayed, performing an operation corresponding to the second user input.

Other aspects, advantages, and salient features of the disclosure will become apparent to those skilled in the art from the following detailed description, which, taken in conjunction with the annexed drawings, discloses one or more example embodiments of the present disclosure.

According to one or more example embodiments, a user may intuitively know an error of a user input through a UI displayed in a display, and the malfunction of a display device may be reduced by allowing a user input to be changed depending on a user intention.

### BRIEF DESCRIPTION OF THE DRAWINGS

The above and other aspects, features, and advantages of example embodiments will be more apparent from the following description taken in conjunction with the accompanying drawings, in which:

FIG. 1 is a block diagram illustrating a configuration of a display device, according to one or more example embodiments;

FIG. 2 is a diagram illustrating an exterior of a display device, according to one or more example embodiments;

FIG. 3 is a view illustrating a UI displayed on a display, according to one or more example embodiments;

FIG. 4 is a view illustrating a UI displayed on a display, according to one or more example embodiments;

FIG. 5 is a view illustrating a UI displayed on a display, according to one or more example embodiments;

FIG. 6 is a view illustrating a UI displayed on a display, according to one or more example embodiments;

FIG. 7 is a view illustrating a UI displayed on a display, according to one or more example embodiments;

FIG. 8 is a view illustrating a UI displayed on a display, according to one or more example embodiments;

FIG. 9 is a view illustrating a UI displayed on a display, according to one or more example embodiments; and

FIG. 10 is a flowchart illustrating a controlling method of a display device, according to one or more example embodiments.

Throughout the drawings, it should be noted that like reference numbers are used to depict the same or similar elements, features, and structures.

### DETAILED DESCRIPTION

Below, one or more example embodiments may be described with reference to accompanying drawings. Accordingly, those of ordinary skill in the art will recognize that modification, equivalent, and/or alternative on the one or more example embodiments described herein can be variously made without departing from the scope and spirit of the present disclosure. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe example embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in one or more example embodiments of this disclosure. In some cases, even if terms are terms which are defined in this disclosure, they may not be interpreted to exclude embodiments of this disclosure.

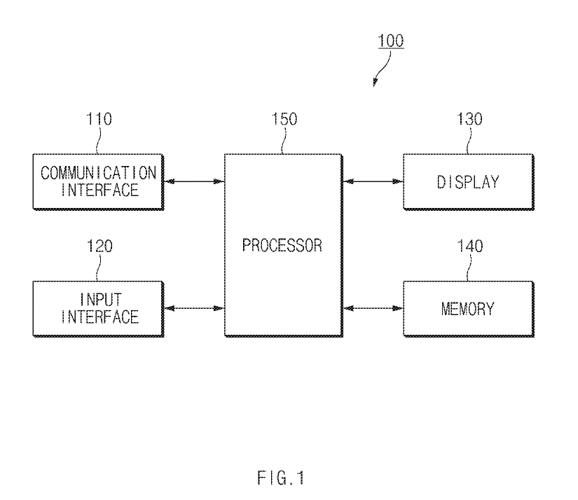

FIG. 1 is a block diagram illustrating a configuration of a display device, according to one or more example embodiments.

Referring to FIG. 1, a display device 100 may include a communication interface 110 (or a communication circuit), an input interface 120 (or an input interface or an input device), a display 130, a memory 140, and a processor 150. According to an example embodiment, the display device 100 may be implemented with various devices, each of which displays contents, such as a TV, a monitor, and the like.

According to an example embodiment, after being connected with a source device by wire or wirelessly, the communication interface 110 may receive the contents from the source device. For example, the communication interface 110 may receive broadcast contents from a broadcast station through a broadcast network or may receive web contents from a web server through an Internet network. For another example, after being connected with the source device through a wired communication interface (e.g., high definition multimedia interface (HDMI) or digital video/visual interactive (DVI), a video graphics array (VGA), or the like) or a short range wireless communication interface (e.g., Bluetooth, near field communication (NFC), wireless-fidelity (Wi-Fi), or the like), the communication interface 110 may receive the contents from the source device.

According to an example embodiment, the communication interface 110 may receive control signal from a remote control device. For example, the communication interface 110 may include at least one of a Bluetooth interface, a Wi-Fi interface, or an infrared (IR) transmitter/receiver. For example, the communication interface 110 may receive the control signal from the remote control device through the above-described interface.

According to an example embodiment, the input interface 120 may receive a user input. According to an example embodiment, the input interface 120 may include at least one of a button, a touch pad, or a jog-shuttle. For example, the input interface 120 may include one or a plurality of buttons. For another example, the input interface 120 may include at least one button and touch pad. For another example, the input interface 120 may include the jog-shuttle that is movable (or pushable) in a plurality of directions (e.g., up, down, left, right, and center directions). For another example, the input interface 120 may include the jog-shuttle that is pushable and rotatable clockwise or counterclockwise.

According to an example embodiment, the display 130 may display contents received from the source device. According to an example embodiment, the display 130 may display a UI. For example, if the user input is received through the input interface 120, the display 130 may display the UI corresponding to the user input. For example, the display 130 may include a liquid crystal display (LCD), a light-emitting diode (LED) display, or an organic LED (OLED) display. According to an example embodiment, after being embedded in the display device 100 or being electrically connected with the display device 100, the display 130 may be placed outside the display device 100.

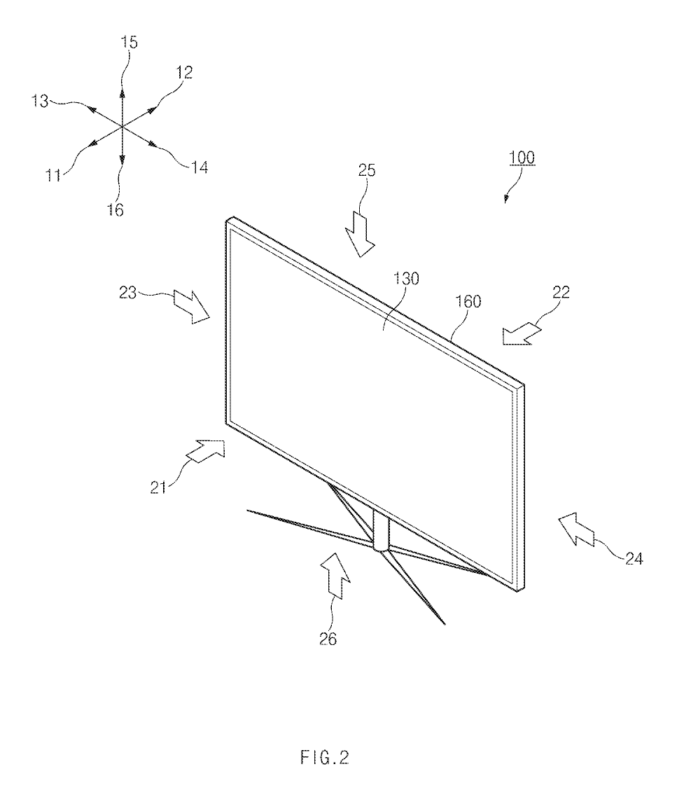

FIG. 2 is a diagram illustrating an exterior of a display device, according to one or more example embodiments.

Referring to FIG. 2, the display device 100 may include the display 130 (or a display device) and a housing 160. Various circuits, modules, interfaces, or the like, such as a processor, a memory, and the like may be disposed in an interior of the display device 100 (i.e., an interior of the housing 160).

According to an example embodiment, the housing 160 may constitute at least part of an exterior of the display device 100. For example, the housing 160 may include a front surface 21 facing in a first direction 11, a rear surface 22 opposite to the front surface 21 and facing in a second direction 12, and a side surface surrounding at least a partial space between the front surface 21 and the rear surface 22. The side surface may include a left-side surface 23 facing in a third direction 13 (or a left-side direction), a right-side surface 24 facing in a fourth direction 14 (or a right-side direction), an upper-side surface 25 facing in a fifth direction 15 (or an upper-side direction), and a bottom-side surface 26 facing in a sixth direction 16 (or a bottom-side direction). According to an example embodiment, to protect various elements in the display device 100 from an external shock or dust, the housing 160 may be formed of a plastic injection molding material, a conductive material (e.g., metal), or a combination thereof.

According to an example embodiment, the display 130 may be disposed in the display device 100 (or on the front surface 21 of the housing 160). For example, the display 130 may be interposed between the front surface 21 facing in the first direction 11 and the rear surface 22 facing in the second direction 12, and may be exposed to the outside through the front surface 21.

According to an example embodiment, the input interface 120 may be disposed on a surface, other than a surface to which the display 130 is exposed, of the housing 160. For example, the input interface 120 may be disposed on the rear surface 22 or at least one of side surfaces 23, 24, 25, and 26, other than the front surface 21 to which the display 130 is exposed.

According to an example embodiment, the memory 140 may store a UI. For example, the UI may include at least one of a shape, a character, an icon, a text, or a symbol.

According to an example embodiment, the processor 150 may control overall operations of the display device 100. For example, the processor 150 may display the UI corresponding to a user input on the display 130 according to one or more example embodiments by controlling each of the communication interface 110, the input interface 120, the display 130, and the memory 140, and then may perform an operation corresponding to the user input.

According to an example embodiment, the display device 100 may include at least one the processor 150. For example, the display device 100 may include a plurality of the processors 150 which executes at least one function. According to an example embodiment, the processor 150 may be implemented with a system on chip (SoC) that includes a central processing unit (CPU), a graphic processing unit (GPU), a memory, and the like.

According to an example embodiment, if the user input is received through the input interface 120, the processor 150 may display the UI corresponding to the user input on the display 130. For example, the UI may include a plurality of objects. For example, if the user input is received through the input interface 120 including a first button, a second button, and a third button, the processor 150 may display the UI including a first object corresponding to the first button, a second object corresponding to the second button, and a third object corresponding to the third button. According to an example embodiment, at least one of shapes and colors of a plurality of objects included in the UI may be different. For example, the first object is an upward arrow shape. The second object may be a circular shape. The third object is a downward arrow shape. For another example, the first object may be a blue color. The second object may be a yellow color. The third object may be a red color.

According to an example embodiment, the processor 150 may display an object, which corresponds to the user input, from among a plurality of objects included in the UI such that the object is distinguished form another object. For example, the processor 150 may display at least one of the color, size, transparency, and display period of the object corresponding to the user input so as to be different from that of another object. For another example, the processor 150 may display at least one of the color, size, transparency, and display period of the object corresponding to the user input so as to be different from an original setting value. For another example, the processor 150 may display at least one of the color, size, transparency, and display period of another object other than the object corresponding to the user input so as to be different from an original setting value.

According to an example embodiment, if the user input is received through the input interface 120 (or if the UI corresponding to the user input is displayed on the display 130), the processor 150 may count the elapsed time after the user input is received (or after the UI is displayed). According to an example embodiment, if a specified time (e.g., 1 second, 2 seconds, 5 seconds, or the like) elapses after the user input is received (or after the UI is displayed), the processor 150 may perform an operation corresponding to the user input. For example, if a specified time elapses after the user input to the first button is received, the processor 150 may increase the channel number or the volume (or an audio level) of a display device. For another example, if the specified time elapses after the user input to the second button is received, the processor 150 may change the mode from a channel changing mode to a volume changing mode. For another example, if a specified time elapses after the user input to the third button is received, the processor 150 may decrease the channel number or the volume of a display device.

According to an example embodiment, if the specified time elapses after the user input is received through the input interface 120 (or after the UI corresponding to the user input is displayed on the display 130), the processor 150 may change at least one of the color, size, transparency, and display period of at least a part of the UI displayed on the display 130. For example, the processor 150 may display at least one of the color, size, transparency, and display period of the object corresponding to the user input so as to be the same as another object. For another example, the processor 150 may display at least one of the color, size, transparency, and display period of the object corresponding to the user input depending on the original setting value. For another example, the processor 150 may display at least one of the color, size, transparency, and display period of another object other than the object corresponding to the user input depending on the original setting value.

According to an example embodiment, the specified time may be set by a user. For example, in the case of a young person, the specified time may be set to be shorter. In the case of an old person, the specified time may be set to be longer. For another example, as soon as the user input is received, the display device 100 may be configured to perform an operation corresponding to the user input.

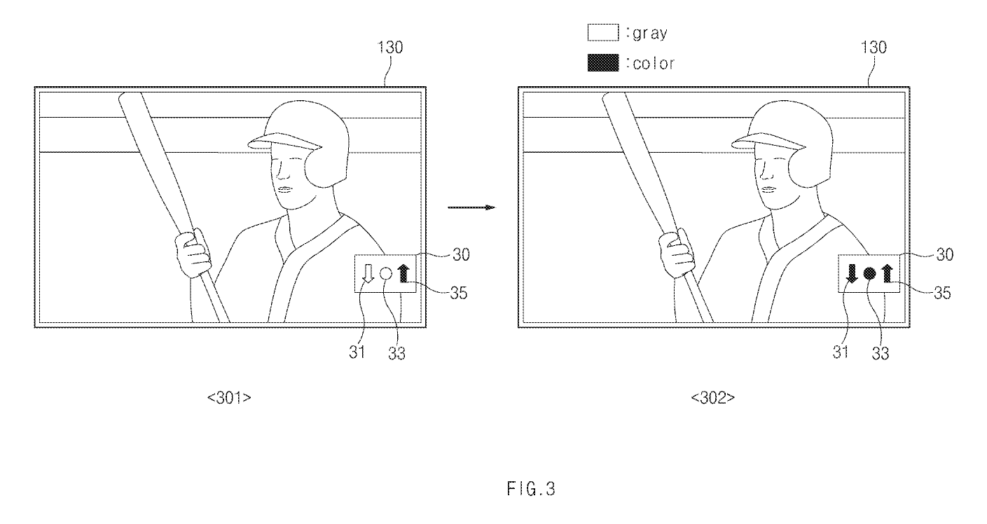

Hereinafter, one or more example embodiments in which a UI is displayed depending on a user input will be described with reference to FIGS. 3 to 7.

FIG. 3 is a view illustrating a UI displayed on a display, according to one or more example embodiments.

Referring to image 301 of FIG. 3, if a user input is received through the input interface 120, the processor 150 may display a UI 30 on the display 130. For example, the UI 30 may include a first object 31 corresponding to a first button, a second object 33 corresponding to a second button, and a third object 35 corresponding to a third button.

According to an example embodiment, the processor 150 may display the color of an object corresponding to the user input to be different from that of another object. For example, if the user input to the third button is received, the processor 150 may display the third object 35 corresponding to the third button in color and may display the first object 31 and the second object 33 in gray. For example, the processor 150 may display the third object 35 depending on an original color or may display the third object 35 in a specified color. An event that an object is displayed in color may indicate that the object is displayed depending on various colors such as a red color, a blue color, a green color, a gray color, or the like, and an event that an object is displayed in gray may indicate that the object is displayed only in white and gray.

Referring to image 302 of FIG. 3, if a specified time elapses after the user input is received (or after the UI 30 is displayed), the processor 150 may change a color of at least one of the first object 31, the second object 33, and the third object 35. For example, the processor 150 may display the first object 31 and the second object 33 in color. For another example, the processor 150 may display the first object 31, the second object 33, and the third object 35 depending on an original color. According to an example embodiment, the processor 150 may perform an operation corresponding to the user input to the third button and may change the color of at least one of the first object 31, the second object 33, and the third object 35 at the same time (or after the color is changed and a specified time elapses).

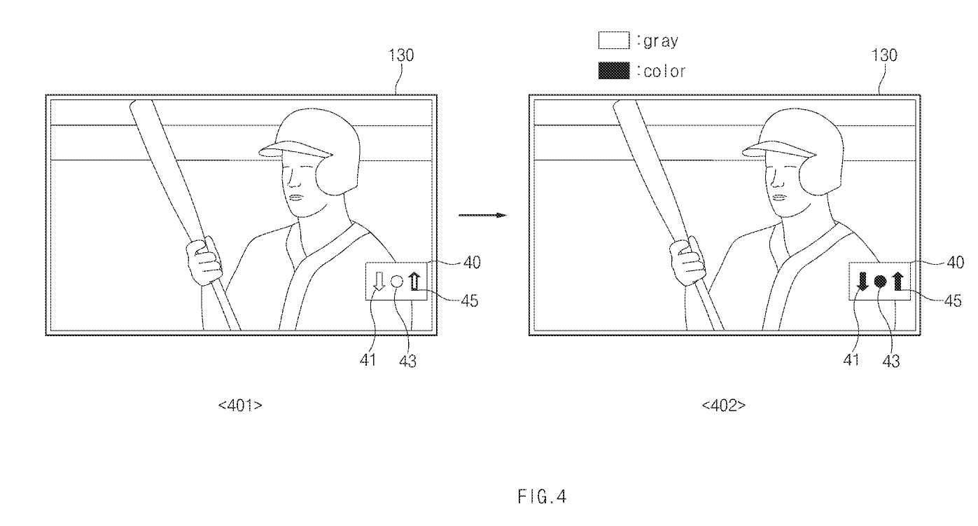

FIG. 4 is a view illustrating a UI displayed on a display, according to one or more example embodiments.

Referring to image 401 of FIG. 4, if a user input is received through the input interface 120, the processor 150 may display a UI 40 on the display 130. For example, the UI 40 may include a first object 41 corresponding to a first button, a second object 43 corresponding to a second button, and a third object 45 corresponding to a third button.

According to an example embodiment, the processor 150 may display the color of an object corresponding to the user input to be different from that of another object. For example, if a user input to the third button is received, the processor 150 may display a part of the third object 45 (e.g., an edge) corresponding to the third button in color and may display the remaining part of the third object 45, the first object 41, and the second object 43 in gray. For example, the processor 150 may display a part of the third object 45 depending on an original color or may display a part of the third object 35 in specified color.

Referring to image 402 of FIG. 4, if a specified time elapses after the user input to the third button is received (or after the UI 40 is displayed), the processor 150 may change a color of at least one of the first object 41, the second object 43, and the third object 45. For example, the processor 150 may display the remaining part of the third object 45, the first object 41, and the second object 43 in color. For another example, the processor 150 may display the first object 41, the second object 43, and the third object 35 depending on an original color. According to an example embodiment, the processor 150 may perform an operation corresponding to the user input to the third button and may change the color of at least one of the first object 41, the second object 43, and the third object 45 at the same time (or after the color is changed and a specified time elapses).

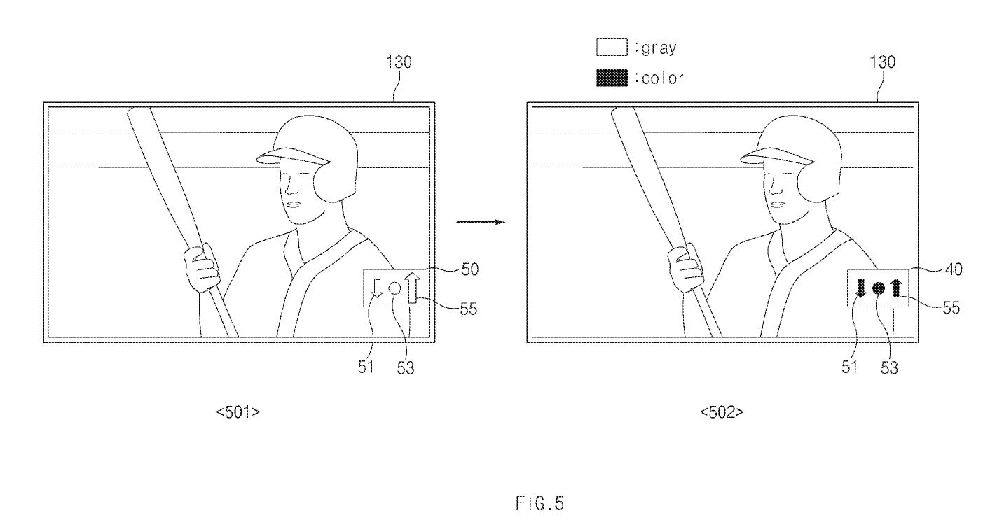

FIG. 5 is a view illustrating a UI displayed on a display, according to one or more example embodiments.

Referring to image 501 of FIG. 5, if a user input is received through the input interface 120, the processor 150 may display a UI 50 on the display 130. For example, the UI 50 may include a first object 51 corresponding to a first button, a second object 53 corresponding to a second button, and a third object 55 corresponding to a third button.

According to an example embodiment, the processor 150 may display a size of an object corresponding to the user input to be different from that of another object. For example, if the user input to the third button is received, the processor 150 may display the third object 55 corresponding to the third button at a first size and may display the first object 51 and the second object 53 at a second size smaller than the first size. For example, the first size may be greater than an original size set to each object, and the second size may be the original size set to each object. For another example, the first size may be the original size set to each object, and the second size may be smaller than the original size set to each object.

Referring to image 502 of FIG. 5, if a specified time elapses after the user input is received (or after the UI 50 is displayed), the processor 150 may change a size of at least one of the first object 51, the second object 53, and the third object 55. For example, the processor 150 may display the third object 55 at the original size. For another example, the processor 150 may display the first object 51 and the second object 53 at the original size. According to an example embodiment, the processor 150 may perform an operation corresponding to the user input to the third button and may change the size of at least one of the first object 51, the second object 53, and the third object 55 at the same time (or after the size is changed and a specified time elapses).

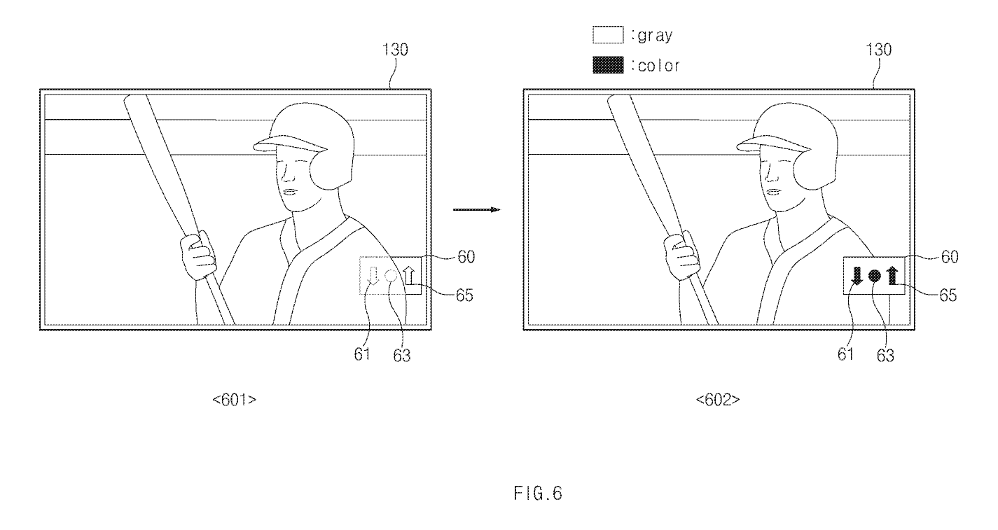

FIG. 6 is a view illustrating a UI displayed on a display, according to one or more example embodiments.

Referring to image 601 of FIG. 6, if a user input is received through the input interface 120, the processor 150 may display a UI 60 on the display 130. For example, the UI 60 may include a first object 61 corresponding to a first button, a second object 63 corresponding to a second button, and a third object 65 corresponding to a third button.

According to an example embodiment, the processor 150 may display the transparency of an object corresponding to the user input to be different from that of another object. For example, if the user input to the third button is received, the processor 150 may display the third object 65 corresponding to the third button with first transparency and may display the first object 61 and the second object 63 with second transparency higher than the first transparency. For example, the first transparency may be the original transparency set to each object, and the second transparency may be higher than the original transparency set to each object. As the transparency of the object is higher, more contents displayed behind the object may be illustrated.

Referring to image 602 of FIG. 6, if a specified time elapses after the user input is received (or after the UI 60 is displayed), the processor 150 may change transparency of at least one of the first object 61, the second object 63, and the third object 65. For example, the processor 150 may display the first object 61 and the second object 63 with original transparency. According to an example embodiment, the processor 150 may perform an operation corresponding to the user input to the third button and may change the transparency of at least one of the first object 61, the second object 63, and the third object 65 at the same time (or after the transparency is changed and a specified time elapses).

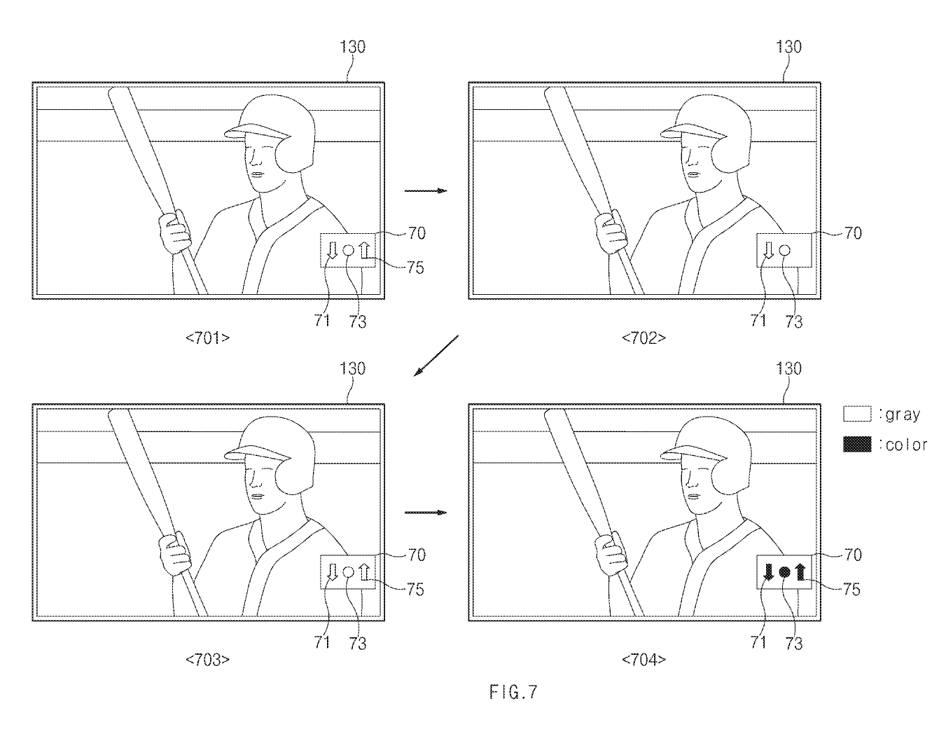

FIG. 7 is a view illustrating a UI displayed on a display, according to one or more example embodiments.

Referring to image 701 of FIG. 7, if a user input is received through the input interface 120, the processor 150 may display a UI 70 on the display 130. For example, the UI 70 may include a first object 71 corresponding to a first button, a second object 73 corresponding to a second button, and a third object 75 corresponding to a third button.

According to an example embodiment, the processor 150 may display an object corresponding to a user input depending on a display period different from that of another object. For example, if the user input to the third button is received, the processor 150 may display the third object 75 corresponding to the third button depending on a first display period and may display the first object 71 and the second object 73 depending on a second display period longer than the first display period. For example, the first display period may be 0.5 second, and the second display period may be infinite. Referring to image 702 of FIG. 7, after being displayed on the display 130 during a specified time, the third object 75 may disappear. Referring to image 703 of FIG. 7, if the display period arrives, the third object 75 may be displayed again on the display 130. For example, the third object 75 may blink depending on the first display period, and the first object 71 and the second object 73 may be continuously displayed without blinking.

Referring to image 704 of FIG. 7, if a specified time elapses after the user input is received (or after the UI 70 is displayed), the processor 150 may change a display period of at least one of the first object 71, the second object 73, and the third object 75. For example, the processor 150 may change the display period of the third object 75 to infinity such that the third object 75 does not blink after the specified time elapses. According to an example embodiment, the processor 150 may perform an operation corresponding to the user input to the third button and may change the display period of at least one of the first object 71, the second object 73, and the third object 75 at the same time (or after the display period is changed and a specified time elapses).

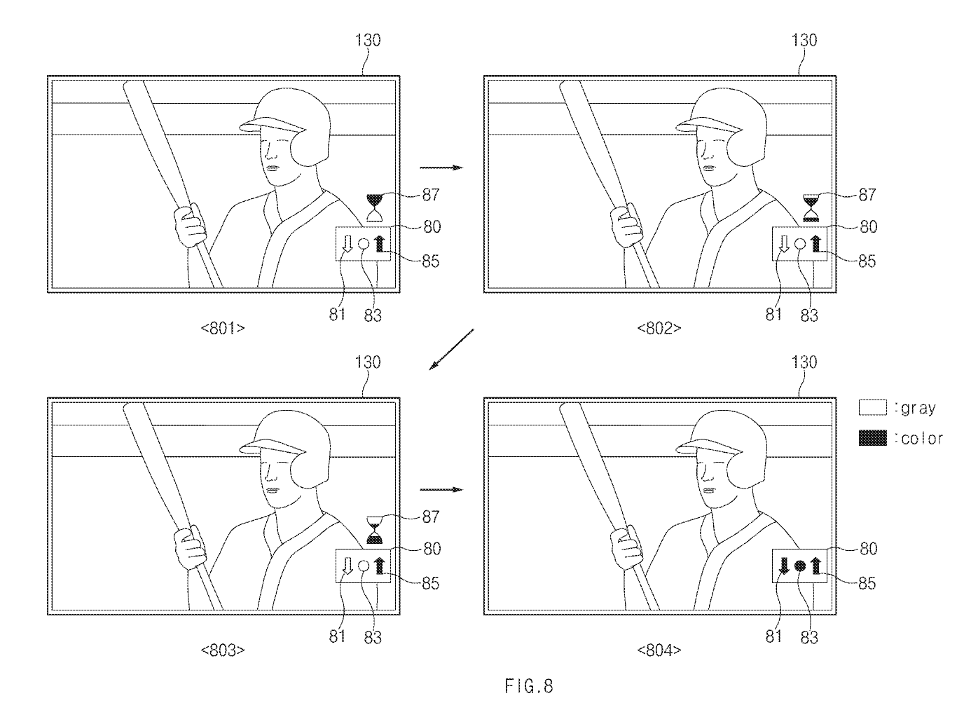

FIG. 8 is a view illustrating a UI displayed on a display, according to one or more example embodiments.

Referring to image 801 of FIG. 8, if a user input is received through the input interface 120, the processor 150 may display a first UI 80 on the display 130. For example, the first UI 80 may include a first object 81 corresponding to a first button, a second object 83 corresponding to a second button, and a third object 85 corresponding to a third button.

According to an example embodiment, the processor 150 may display an object corresponding to a user input such that the object is distinguished from another object. For example, if the user input to the third button is received, the processor 150 may display the third object 85 corresponding to the third button in color and may display the first object 81 and the second object 83 in gray.

According to an example embodiment, if the user input is received through the input interface 120, the processor 150 may display a second UI 87 on the display 130. For example, referring to image 801 of FIG. 8, the processor 150 may display the second UI 87 of a sandglass shape.

According to an example embodiment, the processor 150 may (gradually) change and display at least one from among the location, color, size, shape, transparency, and display period of the second UI 87 during a specified time. For example, referring to image 802 and image 803 of FIG. 8, the processor 150 may change the shape of the second UI 87 during a specified time such that the amount of sand of an upper side of the second UI 87 of the sandglass shape decreases and the amount of sand of a lower side thereof increases. For another example, the processor 150 may increase the transparency of the second UI 87 during a specified time. For another example, the processor 150 may allow the second UI 87 to rotate in a specified direction during a specified time. For another example, the processor 150 may decrease the display period of the second UI 87 during a specified time.

Referring to image 804 of FIG. 8, if a specified time elapses after the user input is received (or after the first UI 80 is displayed), the processor 150 may change at least one of the color, size, transparency, and display period of at least one of the first object 81, the second object 83, and the third object 85. According to an example embodiment, the processor 150 may perform an operation corresponding to the user input to the third button and may change the display period of at least one of the first object 81, the second object 83, and the third object 85 at the same time (or after the display period is changed and a specified time elapses). According to an example embodiment, if a specified time elapses after the user input is received, the processor 150 may allow the second UI 87 to disappear on the display 130.

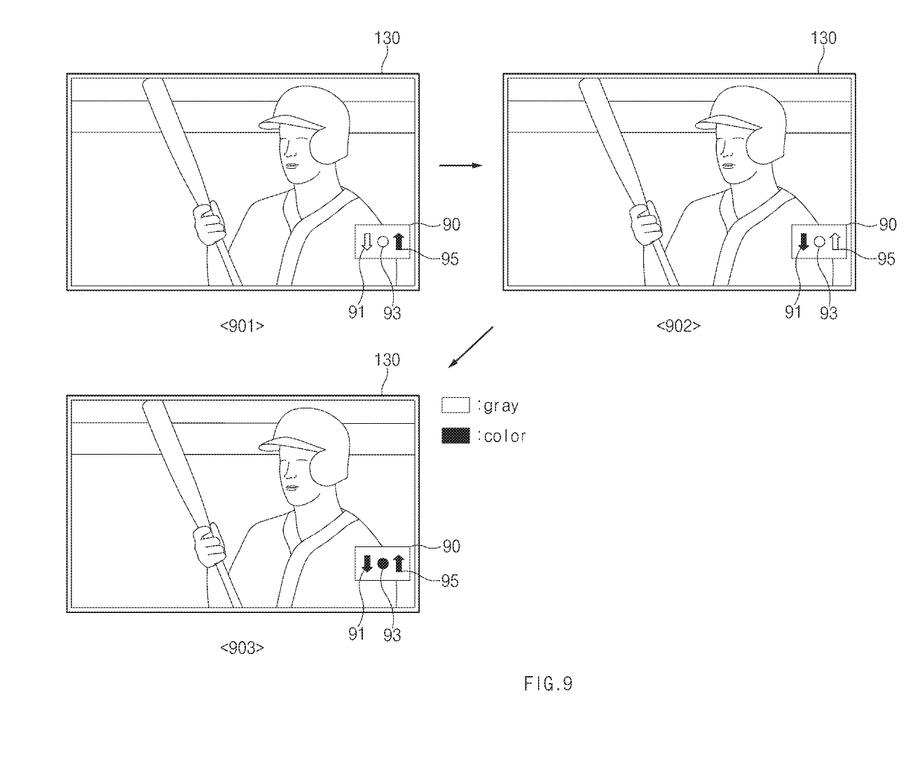

FIG. 9 is a view illustrating a UI displayed on a display, according to one or more example embodiments.

Referring to image 901 of FIG. 9, if a first user input is received through the input interface 120, the processor 150 may display a UI 90 on the display 130. For example, the UI 90 may include a first object 91 corresponding to a first button, a second object 93 corresponding to a second button, and a third object 95 corresponding to a third button.

According to an example embodiment, the processor 150 may display an object corresponding to the first user input such that the object is distinguished from another object. For example, if the first user input to the third button is received, the processor 150 may display the third object 95 corresponding to the third button in color and may display the first object 91 and the second object 93 in gray.

According to an example embodiment, before a specified time elapses after the first user input is received (or after the UI 90 is displayed), the processor 150 may receive a second user input through the input interface 120. According to an example embodiment, if the second user input is received, the processor 150 may display an object corresponding to the second user input such that the object is distinguished from another object. For example, referring to image 902 of FIG. 9, if the second user input to the first button is received, the processor 150 may display the first object 91 corresponding to the first button in color and may display the second object 93 and the third object 95 in gray.

Referring to image 903 of FIG. 9, if a specified time elapses after the second user input is received (or after the UI 90 is changed to correspond to the second user input), the processor 150 may change at least one of the color, size, transparency, and display period of at least one of the first object 91, the second object 93, and the third object 95. For example, the processor 150 may display the second object 93 and the third object 95 in color. According to an example embodiment, if the specified time elapses after the second user input is received, the processor 150 may perform an operation corresponding to the second user input. According to an example embodiment, if the second user input is received, the processor 150 may cancel an operation corresponding to the first user input and may perform an operation corresponding to the second user input.

According to an example embodiment, even though the specified time does not elapse, the processor 150 may perform an operation corresponding to a user input at once on the user input that is received after the processor 150 performs an operation corresponding to a user input. For example, if a user pushes the third button to increase the volume of the display device 100, the volume of the display device 100 may increase by one step. Afterwards, if the user pushes the third button again, the volume of the display device 100 may be changed at once.

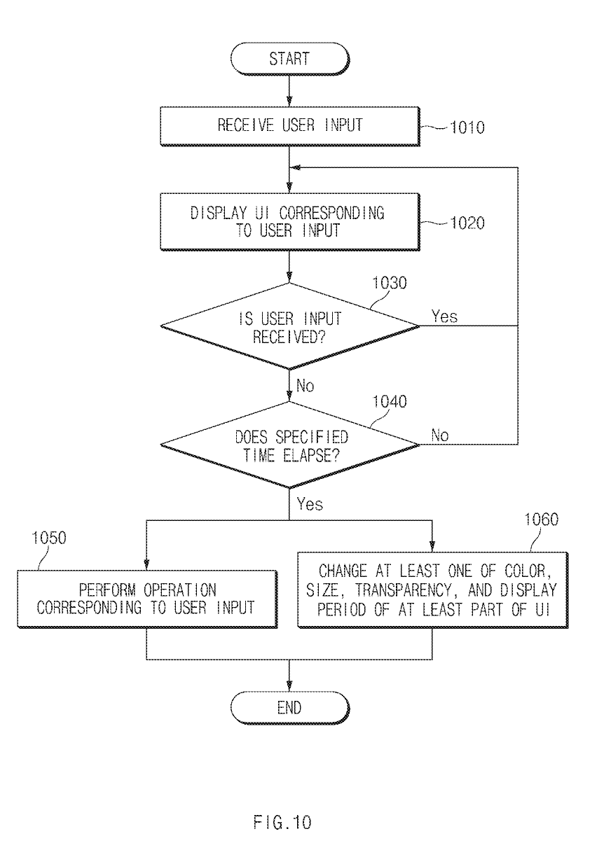

FIG. 10 is a flowchart illustrating a controlling method of a display device, according to one or more example embodiments.

The flowchart illustrated in FIG. 10 may include operations that the above-described display device 100 processes. Even though omitted below, details about the display device 100 described with reference to FIGS. 1 to 9 may be applied to the flowchart illustrated in FIG. 10.

According to an example embodiment, in operation 1010, the display device 100 may receive a user input through an input interface. According to an example embodiment, the input interface may include at least one from among a button, a touch pad, or a jog-shuttle. According to an example embodiment, the input interface may be disposed on a rear surface, other than a front surface to which a display is exposed, or at least one side surface of a housing constituting an exterior of the display device 100.

According to an example embodiment, in operation 1020, the display device 100 may display a UI corresponding to the user input on the display. According to an example embodiment, the display device 100 may display a first UI including a plurality of objects. According to an example embodiment, the display device 100 may display an object, which corresponds to the user input, from among a plurality of objects included in the first UI such that the object is distinguished form another object. For example, the display device 100 may display at least one of the color, size, transparency, and display period of the object corresponding to the user input so as to be different from that of another object.

According to an example embodiment, the display device 100 may further display a second UI. According to an example embodiment, the display device 100 may change and display at least one of the location, color, size, shape, transparency, and display period of the second UI during a specified time.

According to an example embodiment, in operation 1030, the display device 100 may determine whether the user input is received through the input interface. For example, before the specified time elapses after a first user input is received (or after the UI corresponding to the first user input is displayed), the display device 100 may determine whether a second user input is received.

According to an example embodiment, if the user input is received in operation 1030, in operation 1020, the display device 100 may display the UI corresponding to the received user input. For example, the display device 100 may display a UI corresponding to the second user input.

According to an example embodiment, if the user input (e.g., the second user input) is not received in operation 1030, in operation 1040, the display device 100 may determine whether the specified time elapses after the user input (e.g., a first user input) is received (or after a UI corresponding to the first user input is displayed). According to an example embodiment, the specified time may be set by a user.

According to an example embodiment, if the specified time elapses after the user input is received, in operation 1050, the display device 100 may perform an operation corresponding to the user input.

According to an example embodiment, if the specified time elapses after the user input is received, in operation 1060, the display device 100 may change at least one of the color, size, transparency, and display period of at least a part (e.g., at least a part of a plurality of objects included in the first UI) of a UI.

The term “module” used herein may include a unit, which is implemented with hardware, software, and/or firmware, and may be interchangeably used with the terms “logic”, “logical block”, “component”, “circuit”, or the like. The “module” may be a minimum unit of an integrated component or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

According to one or more example embodiments, at least a part of an apparatus (e.g., modules or functions thereof) or a method (e.g., operations) may be, for example, implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The instruction may include codes created by a compiler or codes that are capable of being executed by a computer by using an interpreter. According to one or more example embodiments, a module or a program module may include at least one of the above elements, or a part of the above elements may be omitted, or other elements may be further included.

According to one or more example embodiments, operations executed by modules, program modules, or other elements may be executed by a successive method, a parallel method, a repeated method, or a heuristic method, or at least one part of operations may be executed in different sequences or omitted. Alternatively, other operations may be added. While example embodiments been shown and described with reference to one or more example embodiments thereof, it will be understood by those skilled in the art that various changes in form and details may be made therein without departing from the spirit and scope of the present disclosure, as defined by the appended claims and their equivalents.

What is claimed is:

1. A display device comprising:
a housing disposed at an exterior of the display device;
a display exposed to an outside through a first surface of the housing from among a plurality of surfaces of the housing;
an input interface disposed on at least one surface of the housing other than the first surface, the input interface being configured to receive a user input; and
a processor configured to:
in response to a first user input being received through the input interface, control the display to display a first user interface (UI) corresponding to the first user input on the display; and
in response to a predetermined time elapsing after the first UI is displayed, control the display to display a second UI on the display and perform an operation corresponding to the first user input.

2. The display device of claim 1, wherein the first UI comprises a first object and a second object, the first object corresponding to the first user input,
wherein the processor is further configured to:
control the display to display the first object distinguished from the second object.

3. The display device of claim 2, wherein the processor is further configured to:
control the display to display the second UI in which at least one from among a shape, a color, a size, transparency, and a display period of at least a part of the first object and the second object, is changed.

4. The display device of claim 3, wherein the processor is further configured to:
in response to the first user input being received, control the display to display the first UI in which at least a partial area of the first object is displayed in color and a remainder of the partial area of the first object and the second object are displayed in gray; and
in response to the predetermined time elapsing after the first UI is displayed, control the display to display the second UI in which the first object and the second object are displayed in color.

5. The display device of claim 3, wherein the processor is further configured to:
in response to the first user input being received, control the display to display the first UI in which the first object is displayed at a first size and display the second object at a second size smaller than the first size; and
in response to the predetermined time elapsing after the first UI is displayed, control the display to display the second UI in which the first object and the second object are displayed at the second size.

6. The display device of claim 3, wherein the processor is further configured to:
in response to the first user input being received, control the display to display the first UI in which the first object is displayed with a first transparency and the second object is displayed with a second transparency higher than the first transparency; and
in response to the predetermined time elapsing after the first UI is displayed, control the display to display the second UI in which the first object and the second object are displayed with the first transparency.

7. The display device of claim 3, wherein the processor is further configured to:
in response to the first user input being received, control the display to display the first UI in which the first object is displayed using a first display period and display the second object using a second display period longer than the first display period; and
in response to the predetermined time elapsing after the first UI is displayed, control the display to display the second UI in which the first object and the second object are displayed using the second display period.

8. The display device of claim 1, wherein the input interface comprises at least one from among a button, a touch pad, and a jog-shuttle.

9. The display device of claim 1, wherein the processor is further configured to:
in response to the first user input being received, control the display to display a third UI on the display; and
change at least one from among a location, a color, a size, a shape, transparency, and a display period of the third UI during the predetermined time.

10. The display device of claim 1, wherein the processor is further configured to:
in response to a second user input being received before the predetermined time elapses, control the display to display a fourth UI corresponding to the second user input on the display.

11. The display device of claim 10, wherein the processor is further configured to:
in response to the second user input being received before the predetermined time elapses, cancel the performing of the operation corresponding to the first user input; and
in response to the predetermined time elapsing after the fourth UI is displayed, perform an operation corresponding to the second user input.

12. A controlling method of a display device, the method comprising:
receiving a first user input through an input interface;
displaying a first UI corresponding to the first user input in a display;
in response to a predetermined time elapsing after the first UI is displayed, displaying a second UI on the display and performing an operation corresponding to the first user input.

13. The method of claim 12, wherein the first UI comprises a first object and a second object, the first object corresponding to the first user input,
wherein the displaying of the first UI comprises:
displaying the first object distinguished from the second object, and
wherein the displaying of the second UI comprises:
changing at least one from among a shape, a color, a size, transparency, and a display period of at least a part of a plurality of objects included in the first UI.

14. The method of claim 13, wherein the displaying of the first UI comprises:
displaying at least a partial area of the first object in color; and
displaying a remainder of the partial area of the first object and the second object in gray, and
wherein the displaying of the second UI comprises:
displaying the first object and the second object in color.

15. The method of claim 13, wherein the displaying of the first UI comprises:
displaying the first object at a first size; and
displaying the second object at a second size smaller than the first size, and
wherein the displaying of the second UI comprises:
displaying the first object and the second object at the second size.

16. The method of claim 13, wherein the displaying of the first UI comprises:
displaying the first object with first transparency; and
displaying the second object with second transparency higher than the first transparency, and
wherein the displaying of the second UI comprises:
displaying the first object and the second object with the first transparency.

17. The method of claim 13, wherein the displaying of the first UI comprises:
displaying the first object using a first display period; and
displaying the second object using a second display period longer than the first display period, and
wherein the displaying of the second UI comprises:
displaying the first object and the second object using the second display period.

18. The method of claim 12, further comprising:
in response to the first user input being received, displaying a third UI on the display; and
changing at least one from among a location, a color, a size, a shape, transparency, and a display period of the third UI during the predetermined time.

19. The method of claim 12, further comprising:
before the predetermined time elapses, receiving a second user input; and
displaying a fourth UI corresponding to the second user input on the display.

20. The method of claim 19, further comprising:
in response to the second user input being received, canceling the performing of the operation corresponding to the first user input; and
in response to the predetermined time elapsing after the fourth UI is displayed, performing an operation corresponding to the second user input.
